(19) United States
(12) Patent Application Publication
(10) Pub. No.: US 2009/0008011 A1
(43) Pub. Date: Jan. 8, 2009

(54) Pneumatic Tire

(75) Inventors: Jie Jin, Copley, OH (US); John Turner, Akron, OH (US); Richard Wright, Wadsworth, OH (US)

Correspondence Address: Chief Intellectual Property Counsel;Bridgestone Americas Holding, Inc., 1200 Firestone Parkway, Akron, OH, 44317-0001, US

(73) Assignee: Bridgestone Firestone North American Tire, LLC, Nashville, TN (US)

(21) Appl. No.: 11/772,736

(22) Filed: Jul. 2, 2007

(51) Int. Cl. B60C 11/13

(52) U.S. Cl. 152/209.14

(57) ABSTRACT

A pneumatic tire having an equatorial plane and a maximum section width is provided. The tire includes a tread portion having outer tread edges that define a tread arc therebetween, a pair of sidewall portions, a pair of bead portions each of which has a bead core, at least one carcass ply extending circumferentially about the tire from one bead portion to the other and wound outwardly about the bead cores to form a pair of turn-up portions that each terminate at a turn-up, and at least one belt provided between the tread portion and the at least one carcass ply. When the tire is inflated to its specified inflated pressure, the tread portion has a profile that includes a central arc, a pair of intermediate arcs each of which intersects opposite edges of the central arc at a first intersection point, and a pair of outer arcs each of which intersects a respective intermediate arc at a second intersection point. The arc length measured from the equatorial plane of the tire to at least one of the first intersection points is between about 20% and about 60% of one half of the tread arc of the tire, while the arc length measured from the equatorial plane of the tire to at least one of the second intersection points is between about 40% and about 80% of one half of the tread arc of the tire.

### FIELD OF THE INVENTION

The present application relates to pneumatic tires and, more particularly, to pneumatic tires having a tread profile defined by multiple arcs having different radii of curvature.

### BACKGROUND

It is well known that many characteristics or features of a pneumatic tire may impact its performance, wear, noise generation, and the like. One such feature is the footprint of the tire. As is generally understood, the footprint of a tire constitutes the contact patch or area of contact of the tire tread with a planar surface at zero speed when the tire is inflated to a certain pressure and is subjected to a predetermined load.

Generally, when the loading on a tire changes, the size of the footprint changes. For example, if the loading on a tire increases, the size of the footprint can increase. Moreover, when the loading on a tire changes, the distribution of the contact pressure within the footprint of the tire typically changes. Both the change in footprint size and contact pressure distribution can lead to uneven tread wear and poor tire performance.

### SUMMARY

In one embodiment, a pneumatic tire having an equatorial plane and a maximum section width is provided. The tire includes a tread portion having outer tread edges that define a tread arc therebetween, a pair of sidewall portions, a pair of bead portions each of which has a bead core, at least one carcass ply extending circumferentially about the tire from one bead portion to the other and wound outwardly about the bead cores to form a pair of turn-up portions that each terminate at a turn-up, and at least one belt provided between the tread portion and the at least one carcass ply. When the tire is inflated to its specified inflated pressure, the tread portion has a profile that includes a central arc, a pair of intermediate arcs each of which intersects opposite edges of the central arc at a first intersection point, and a pair of outer arcs each of which intersects a respective intermediate arc at a second intersection point. The arc length measured from the equatorial plane of the tire to at least one of the first intersection points is between about 20% and about 60% of one half of the tread arc of the tire, while the arc length measured from the equatorial plane of the tire to at least one of the second intersection points is between about 40% and about 80% of one half of the tread arc of the tire.

### BRIEF DESCRIPTION OF DRAWINGS

The accompanying drawings, together with the detailed description provided below, describe exemplary embodiments of the claimed invention. In the drawings and description that follow, like elements are identified with the same reference numerals. The drawings are not to scale and the proportion of certain elements may be exaggerated for the purpose of illustration.

FIG. 1 illustrates a cross-sectional view of one embodiment of one half of a tire 100.

FIG. 2 illustrates an enlarged view of an exemplary profile of the tread portion 102 of the tire 100.

FIG. 3 illustrates a graph comparing the footprint contact pressure distributions of a tire having a conventional tread profile with a tire having a tread profile defined by three arcs, each of which has a different radius of curvature.

### DETAILED DESCRIPTION

The following includes definitions of selected terms employed herein. The definitions include various examples and/or forms of components that fall within the scope of a term. The examples are not intended to be limiting.

“Axial” or “axially” refer to a direction that is parallel to the axis of rotation of a tire.

“Circumferential” and “circumferentially” refer to a direction extending along the perimeter of the surface of the tread parallel to the equatorial plane perpendicular to the axial direction of the tire.

“Equatorial plane” refers to the plane that is perpendicular to the tire's axis of rotation and passes through the center of the tire's tread.

“Lateral” or “laterally” refer to a direction along the tread of the tire going from one sidewall of the tire to the other sidewall.

“Radial” or “radially” refer to a direction perpendicular to the axis of rotation of the tire.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

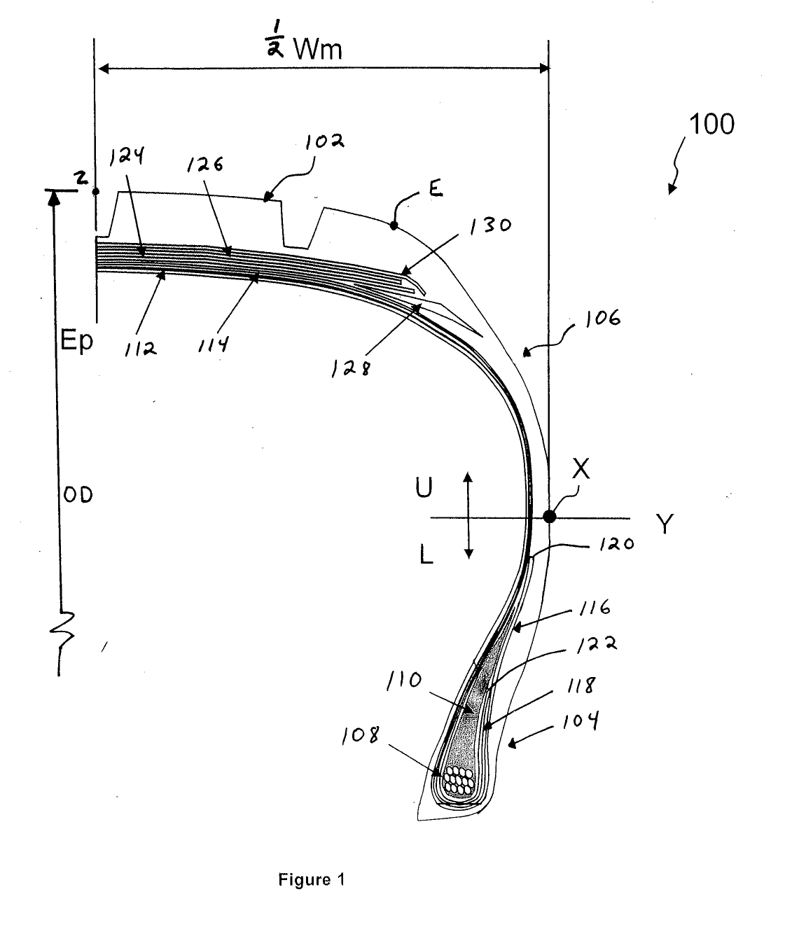

Illustrated in FIG. 1 is a cross-sectional view of half of one embodiment of a tire 100. Although only half of the tire 100 is depicted in the drawings, it will be appreciated that the other half of the tire 100 is a substantial mirror image thereof. The tire 100 has an equatorial plane Eₚ and a maximum section width Wₘ measured from one outer most point (i.e., point X) of the tire 100 to the other. Accordingly, one half of the maximum section width (½ Wₘ) is the distance between the equatorial plane Eₚ and one of the outer most points of the tire 100. The tire 100 also has an outer diameter OD measured from the upper point (i.e., point Z) of the tire 100 to the lower most point (not shown) of the tire 100 along the equatorial plane Eₚ.

The tire 100 can be divided into two sections—an upper section U and a lower section L. Separating the upper section U from the lower section L is a hypothetical line Y drawn through point X that is parallel to the axis of rotation of the tire 100. The upper section U is the portion of the tire 100 that is disposed above the hypothetical line Y, while the lower section L is disposed below the hypothetical line Y.

With continued reference to FIG. 1, the tire 100 includes a circumferential tread portion 102 having tread edges E, a pair of axially spaced bead portions 104, and a pair of sidewall portions 106. Each bead portion 104 includes a bead core 108 and a bead filler 110. It will be appreciated that the tread portion 102 of the tire can be provided with any number of grooves, slots, and/or sipes to form a variety of different tread patterns. All tread patterns are within the scope of this application. Moreover, the specific tread profile described above can apply any tire size and aspect ratio.

It will be appreciated that any tire construction can be utilized. In the illustrated embodiment, the tire 100 includes first and second carcass plies 112, 114 that extend circumferentially about the tire 100 from one bead portion 104 to the other. Although the tire 100 illustrated in FIG. 1 includes two carcass plies, the tire 100 can include a single carcass ply or more than two carcass plies in alternative embodiments (not shown).

The first and second carcass plies 112, 114 are wound outwardly about each bead core 108 and extend upwardly towards the tread portion 102 to form first and second turn-up portions 116, 118, respectively, terminate at first and second turn-up ends 120, 122, respectively. As shown in FIG. 1, the first turn-up portion 116 of the first carcass ply 112 terminates near the hypothetical line Y, while the second turn-up portion 118 of the second carcass ply 114 terminates near the bead portion 104 of the tire 100. In another embodiment (not shown), the first turn-up portion 118 of the first carcass ply 114 can terminate near or in the bead portion 104 of the tire 100. In other embodiments (not shown), the first turn-up portion 118 of the first carcass ply 114 and/or the second turn-up portion 118 of the second carcass ply 114 can terminate beneath a respective tread edge E of the tire 100. In the case of a monoply construction, the turn-up portion of the single carcass play can terminate beneath a respective tread edge E of the tire 100, near the hypothetical line Y, or near or in the bead portion 104 of the tire 100. It will be appreciated, however, that the termination end(s) of the turn-up portion(s) is not limited to the above-described embodiments.

In one embodiment, the first and second carcass plies 112, 114 include parallel-aligned cords that are radially disposed. In other words, the parallel-aligned cords are oriented substantially perpendicular to the equatorial plane Eₚ of the tire 100. In alternative embodiments, one or more of the carcass plies can include parallel-aligned cords that are biased with respect to the equatorial plane Eₚ of the tire 100. In all cases, the cords can be constructed of, for example, nylon, polyester, or rayon.

With continued reference to FIG. 1, the tire 100 further includes first and second belts 124, 126 that extend circumferentially about the tire 100. The first and second belts 124, 126 are provided between the tread portion 102 and the first and second carcass plies 112, 114. Although the tire 100 illustrated in FIG. 1 features two belts, the tire 100 can include no belts, a single belt, or more than two belts in alternative embodiments (not shown).

In one embodiment, the first and second belts 124, 126 include parallel-aligned cords or wires that are radially disposed. In alternative embodiments, one or more of the belts can include parallel-aligned cords or wires that are biased with respect to the equatorial plane Ep of the tire 100. In all cases, the cords or wires can be constructed of, for example, steel or other steel alloys.

With continued reference to FIG. 1, the tire 100 also includes a belt edge insert 128 provided between the edges of the first and second belts 124, 126 and the first and second carcass plies 112, 114. The belt edge insert 128 is configured to protect the carcass plies 112, 114 from the edges of the belts 124, 126. The belt edge insert 128 may be constructed of extruded rubber or another elastomeric material. Although shown in the FIG. 1 embodiment, the belt edge insert 128 is optional and may be omitted in alternative embodiments (not shown).

The tire 100 further includes one or more cap plies 130 provided between the tread 102 and the first and second belts 124, 126. The cap ply 130 can be used to assist in holding the components of the tire together (e.g., the belts, plies, and tread). Each cap ply 130 can include, for example, a polyester or nylon fabric ply. Although shown in the FIG. 1 embodiment, the cap ply 130 is optional and may be omitted in alternative embodiments (not shown).

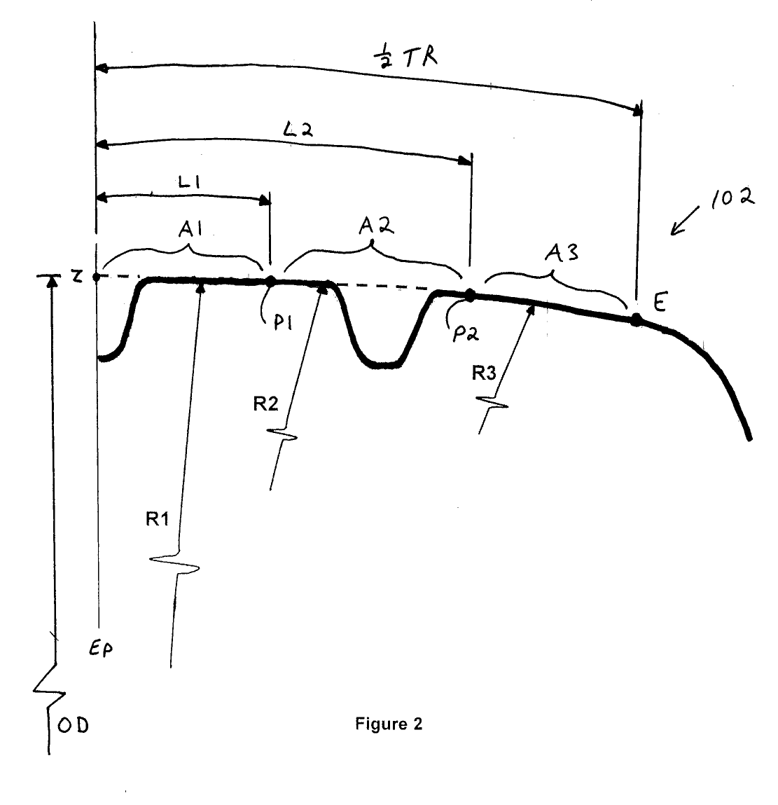

Illustrated in FIG. 2 is an enlarged view of an exemplary profile of the tread portion 102 of the tire 100. It will be appreciated, however, that the profile of a tire tread is not limited to this embodiment. As shown in FIG. 2, the tread portion 102 has a reference arc TR measured from one tread edge E to the other (not shown). Accordingly, one half of the tread arc (½ TR) of the tire 100 is defined from the equatorial plane Eₚ to the tread edge E. In one embodiment, the arc length of one half of the tread arc (½ TR) is between about 70% and about 95% of one half of the maximum section width Wₘ (½ Wₘ) of the tire 100. In another embodiment, the arc length of one half of the tread arc (½ TR) is between about 75% and about 90% of one half of the maximum section width Wₘ (½ Wₘ) of the tire 100.

When the tire 100 is mounted on a specified rim and inflated to its specified inflation pressure (e.g., 26 psi for a standard load passenger tire or 50 psi for a load range “C” light truck tire), the tread portion 102 has a lateral profile taken in a plane that contains the axis of rotation of the tire 100. In one embodiment, one half of the profile of the tread portion 102 of the tire 100 is defined by at least three arcs. In the illustrated embodiment, the profile of the tread portion 102 of the tire 100 is defined by a central arc A1, a pair of intermediate arcs A2, and a pair of outer arcs A3. Each intermediate arc A2 is tangent to and intersects opposite edges of the central arc A1 at a first intersection point P1, while each outer arc A3 is tangent to and intersects a respective intermediate arc A2 at a second intersection point P2.

In one embodiment, the central arc A1 has a radius of curvature R1 centered on the equatorial plane Ep of the tire 100. In one embodiment, the arc length L1 measured from the equatorial plane Ep of the tire 100 to the first intersection point P1 is between about 20% and about 60% of one half of the tread arc (½ TR) of the tire 100. In another embodiment, the arc length L1 measured from the equatorial plane Ep of the tire 100 to the first intersection point P1 is between about 30% and about 50% of one half of the tread arc (½ TR) of the tire 100. In both embodiments, the radius of curvature R1 of the intermediate arcs A1 is between about 0.5 to about 5.0 times the outer diameter OD of the tire 100.

In one embodiment, each intermediate arc A2 has a radius of curvature R2 centered on the radius of curvature R1 of the central arc A1. In one embodiment, the arc length L2 measured from the equatorial plane Ep of the tire 100 to the second intersection point P2 is between about 40% and about 80% of one half of the tread arc (½ TR) of the tire 100. In another embodiment, the arc length L2 measured from the equatorial plane Ep of the tire 100 to the second intersection point P2 is between about 50% and about 70% of one half of the tread arc (½ TR) of the tire 100.

In one embodiment, each outer arc A3 has a radius of curvature R3 centered on the radius of curvature R2 of a respective intermediate arc A2.

In one embodiment, the ratio of the radius of curvature R1 of the central arc A1 to the radius of curvature R2 of each intermediate arc A2 (i.e., R1/R2) is between about 0.5 and about 4.0. In another embodiment, the ratio of R1/R2 is between about 1.5 and about 3.0. In one embodiment, the ratio of the radius of curvature R2 of each intermediate arc A2 to the radius of curvature R3 of each outer arc A3 (i.e., R2/R3) is between about 0.5 and about 10.0. In another embodiment, the ratio of R2/R3 is between about 2 and about 6.

By providing a tire with a tread profile defined by at least three radii, changes in footprint size and contact pressure can be minimized. While not wishing to be bound by theory, it is believed that the tread profile of a tire under certain inflation pressure can affect the belt(s) positioned within the tire. The inflated belt position influences its cord tension and tension distribution from the center of the tire to its shoulders. The tread profile defined by at least three radii, as described herein, can be helpful in altering the cord tension in the tire to maintain footprint ratio and contact pressure distribution under different loads, so that the impact of this design to tire performance is beneficial.

The following example demonstrates another potential advantage of a tire provided with a tread profile defined by multiple arcs having different radii of curvature according to the specifications discussed above. This example should not be construed as limiting the scope or spirit of the present application.

### EXAMPLE 1

A conventional LT265/75R/16 tire, having a tread profile defined by a single arc having a single radius of curvature of 504 mm (hereinafter referred to as the “Conventional Tire”), was inflated to 50 psi, subjected to a vertical load of 2470 lbs., and tested to determine the distribution of footprint contact pressure. A new LT265/75R/16 tire, having a tread profile defined by three arcs having three different radii of curvature where R1=1358 mm, R2=679 mm, R3=161 mm, L1=30%, L2=48%, and ½ TR=78% of ½Wₘ (hereinafter referred to as the “New Tire”), was inflated to 50 psi, subjected to a vertical load of 2470 lbs., and also tested to determine the distribution of footprint contact pressure. Both the Conventional Tire and the New Tire were manufactured with the same tread pattern and tire construction, with the only notable difference being the tread profile.

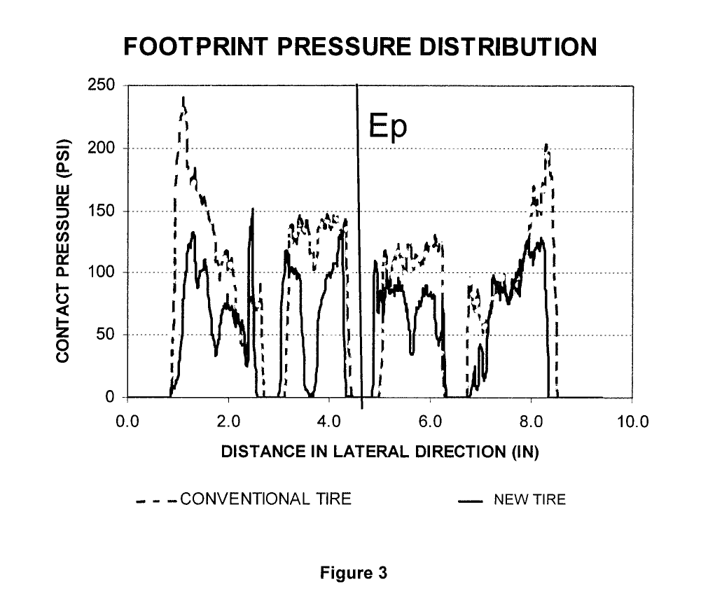

Illustrated in FIG. 3 is a graph comparing the footprint contact pressure distributions of the Conventional Tire with the New Tire. The x-axis of the graph represents the lateral distance in inches across the tires, while the y-axis represents the contact pressure in pounds per square inch (psi). As shown in the graph in FIG. 3, it is quite evident that the footprint contract pressure distribution of the New Tire is more uniformly distributed than the footprint contract pressure distribution of the Conventional Tire. A more consistent footprint contract pressure distribution provides for better performance in tire wear and traction.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” is employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.”

While the present application illustrates various embodiments, and while these embodiments have been described in some detail, it is not the intention of the applicant to restrict or in any way limit the scope of the claimed invention to such detail. Departures may be made from such details without departing from the spirit or scope of the applicant's claimed invention. Therefore, the invention, in its broader aspects, is not limited to the specific details, the representative apparatus, and illustrative examples shown and described.

1. A pneumatic tire inflated to its specified inflated pressure, the tire having an equatorial plane and a maximum section width, the tire comprising:
a tread portion having outer tread edges that define a tread arc therebetween;
a pair of sidewall portions;
a pair of bead portions, each of which has a bead core;
at least one carcass ply extending circumferentially about the tire from one bead portion to the other and wound outwardly about the bead cores to form a pair of turn-up portions that each terminate at a turn-up; and
at least one belt provided between the tread portion and the at least one carcass ply,
wherein the tread portion has a profile that includes a central arc, a pair of intermediate arcs each of which intersects opposite edges of the central arc at a first intersection point, and a pair of outer arcs each of which intersects a respective intermediate arc at a second intersection point,
wherein the arc length measured from the equatorial plane of the tire to at least one of the first intersection points is between about 20% and about 60% of one half of the tread arc of the tire,
wherein the arc length measured from the equatorial plane of the tire to at least one of the second intersection points is between about 40% and about 80% of one half of the tread arc of the tire.

2. The tire of claim 1, wherein the central, intermediate, and outer arcs have first, second, and third radii of curvature, respectively, that are different from each other.

3. The tire of claim 2, wherein the central arc and each intermediate arc is tangent to each other at the first intersection points and each intermediate arc and a respective outer arc is tangent to each other at the second intersection points.

4. The tire of claim 2, wherein the ratio of the first radius of curvature of the central arc to the second radius of curvature of the intermediate arcs is between about 0.5 to about 4.0.

5. The tire of claim 2, wherein the ratio of the second radius of curvature of the intermediate arcs to the third radius of curvature of the outer arcs is between about 0.5 to about 10.0.

6. The tire of claim 2, wherein the first radius of curvature of the central arc is centered on the equatorial plane of the tire.

7. The tire of claim 2, wherein the second radius of curvature of each intermediate arc is centered on the first radius of curvature of the central arc.

8. The tire of claim 2, wherein the third radius of curvature of each outer arc is centered on the second radius of curvature of a respective intermediate arc.

9. The tire of claim 1, wherein the tread arc is between about 70% and about 95% of the maximum section width.

10. The tire of claim 1, wherein the arc length measured from the equatorial plane of the tire to at least one of the first intersection points is between about 30% and about 50% of one half of the tread arc of the tire.

11. The tire of claim 1, wherein the arc length measured from the equatorial plane of the tire to at least one of the second intersection points is between about 50% and about 70% of one half of the tread arc of the tire.

12. A pneumatic tire inflated to its specified inflated pressure, the tire having an equatorial plane, an outer diameter measured along the equatorial plane, and a maximum section width, the tire comprising:
a tread portion having tread edges that define a tread arc therebetween that is between about 70% and about 95% of the maximum section width;
a pair of sidewall portions;
a pair of bead portions, each of which has a bead core;
at least one carcass ply extending circumferentially about the tire from one bead portion to the other and wound outwardly about the bead cores to form a pair of turn-up portions that each terminate at a turn-up; and
at least one belt provided between the tread portion and the at least one carcass ply,
wherein the tread portion has a profile that includes a central arc, a pair of intermediate arcs each of which intersects opposite edges of the central arc at a first intersection point, and a pair of outer arcs each of which intersects a respective intermediate arc at a second intersection point,
wherein the central, intermediate, and outer arcs have first, second, and third radii of curvature, respectively, that are different from each other,
wherein the axial length measured from the equatorial plane of the tire to at least one of the first intersection points is between about 20% and about 60% of one half of the tread arc of the tire,
wherein the axial length measured from the equatorial plane of the tire to at least one of the second intersection points is between about 40% and about 80% of one half of the tread arc of the tire.

13. The tire of claim 12, wherein the ratio of the first radius of curvature of the central arc to the second radius of curvature of the intermediate arcs is between about 0.5 to about 4.0.

14. The tire of claim 12, wherein the ratio of the second radius of curvature of the intermediate arcs to the third radius of curvature of the outer arcs is between about 0.5 to about 10.0.

15. The tire of claim 12, wherein the ratio of the first radius of curvature of the central arc to the second radius of curvature of each intermediate arc is between about 0.5 to about 4.0 and the ratio of the second radius of curvature of the intermediate arcs to the third radius of curvature of the outer arcs is between about 0.5 to about 10.0.

16. The tire of claim 12, wherein the first radius of curvature of the central arc is centered on the equatorial plane of the tire and ranges from between about 0.5 to about 5.0 times the outer diameter of the tire.

17. The tire of claim 12, wherein the central arc and each intermediate arc is tangent to each other at the first intersection points and each intermediate arc and a respective outer arc is tangent to each other at the second intersection points.

18. The tire of claim 12, wherein the first radius of curvature of the central arc is centered on the equatorial plane of the tire.

19. The tire of claim 12, wherein the second radius of curvature of each intermediate arc is centered on the first radius of curvature of the central arc.

20. The tire of claim 12, wherein the third radius of curvature of each outer arc is centered on the second radius of curvature of a respective intermediate arc.
